(19) United States
(12) Patent Application Publication
(10) Pub. No.: US 2026/0136299 A1
(43) Pub. Date: May 14, 2026

(54) Distributed Deep Reinforcement Learning to Increase Physical Uplink Shared Channel Throughput

(71) Applicant: Dell Products L.P., Round Rock, TX (US)

(72) Inventors: Yasser AlEryani, Kanata (CA); Satish Venkob, Mississauga, CA (US); Manbir Kaur, Brampton, CA (US)

(21) Appl. No.: 18/942,111

(22) Filed: Nov. 8, 2024

(51) Int. Cl. H04W 52/14; H04L 41/16; H04W 52/36

(52) U.S. Cl. CPC H04W 52/146; H04L 41/16; H04W 52/365

(57) ABSTRACT

A system can communicate broadband cellular communications with a group of user equipment, wherein respective user equipment of the group of user equipment execute respective distributed deep reinforcement learning agents that are configured to determine respective transmission power levels for respective physical uplink shared channel transmissions based on respective local observations and respective learned policies. The system can determine, using a centralized deep reinforcement learning agent, respective transmission power control commands for the respective user equipment, the respective user equipment utilizing the respective transmission power control commands as constraints in the respective distributed deep reinforcement learning agents. The system can receive the respective physical uplink shared channel transmissions from the respective user equipment according to the respective transmission power levels.

### BACKGROUND

In broadband cellular networks, a base station (sometimes referred to as a gNodeB (gNB) can communicate with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can communicate broadband cellular communications with a group of user equipment, wherein respective user equipment of the group of user equipment execute respective distributed deep reinforcement learning agents that are configured to determine respective transmission power levels for respective physical uplink shared channel transmissions based on respective local observations and respective learned policies. The system can determine, using a centralized deep reinforcement learning agent, respective transmission power control commands for the respective user equipment, the respective user equipment utilizing the respective transmission power control commands as constraints in the respective distributed deep reinforcement learning agents. The system can receive the respective physical uplink shared channel transmissions from the respective user equipment according to the respective transmission power levels.

An example method can comprise facilitating, by a system comprising at least one processor, communicating, with user equipment, wherein respective user equipment of the user equipment execute respective distributed deep reinforcement learning agents that are configured to determine respective transmission power levels for respective physical uplink shared channel transmissions. The method can further comprise determining, with a centralized deep reinforcement learning agent of the system, respective transmission power control commands for the respective user equipment, the respective user equipment utilizing the respective transmission power control commands as constraints in the respective distributed deep reinforcement learning agents. The method can further comprise facilitating, by the system, receiving the respective physical uplink shared channel transmissions from the respective user equipment according to the respective transmission power levels.

An example non-transitory computer-readable medium can comprise instructions that, in response to execution, cause a system comprising a processor to perform operations. These operations can comprise determining, using a first reinforcement learning agent, respective transmission power control commands for respective devices of devices with which the system is enabled to communicate, wherein the respective devices execute respective second reinforcement learning agents that are configured to determine respective transmission power levels for respective physical uplink shared channel transmissions, and wherein the respective devices utilize the respective transmission power control commands as constraints in the respective second reinforcement learning agents. These operations can further comprise receiving the respective physical uplink shared channel transmissions from the respective devices according to the respective transmission power levels.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate distributed deep reinforcement learning (DRL) to increase physical uplink shared channel (PUSCH) throughput, in accordance with an embodiment of this disclosure;

FIG. 2 illustrates another example system architecture that can facilitate distributed DRL to increase PUSCH throughput, in accordance with an embodiment of this disclosure;

FIG. 3 illustrates an example of a reward function, and that can facilitate distributed DRL to increase PUSCH throughput, in accordance with an embodiment of this disclosure;

FIG. 4 illustrates an example of UE constraints, and that can facilitate distributed DRL to increase PUSCH throughput, in accordance with an embodiment of this disclosure;

FIG. 5 illustrates an example of a state vector for a centralized DRL, and that can facilitate distributed DRL to increase PUSCH throughput, in accordance with an embodiment of this disclosure;

FIG. 6 illustrates an example of a state vector for a distributed DRL, and that can facilitate distributed DRL to increase PUSCH throughput, in accordance with an embodiment of this disclosure;

FIG. 7 illustrates an example signal flow for training in a two UE scenario, and that can facilitate distributed DRL to increase PUSCH throughput, in accordance with an embodiment of this disclosure;

FIG. 8 illustrates an example process flow that can facilitate distributed DRL to increase PUSCH throughput, in accordance with an embodiment of this disclosure;

FIG. 9 illustrates another example process flow that can facilitate distributed DRL to increase PUSCH throughput, in accordance with an embodiment of this disclosure;

FIG. 10 illustrates another example process flow that can facilitate distributed DRL to increase PUSCH throughput, in accordance with an embodiment of this disclosure; and

FIG. 11 illustrates an example block diagram of a computer operable to execute an embodiment of this disclosure.

### DETAILED DESCRIPTION

### Overview

While the present examples generally relate to fifth generation (5G) broadband cellular communications, it can be appreciated that the present techniques can generally be applied to other scenarios, such as Long Term Evolution (LTE) or sixth generation (6G) broadband cellular networks.

PUSCH can generally comprise a broadband cellular communications channel that is used to transmit information from a UE to a base station. This information can comprise radio resource control (RRC) signaling messages, uplink control information (UCI), and application data.

In the realm of Radio Access Network (RAN) optimization, there can be a problem relating to maximizing Physical Uplink Shared Channel (PUSCH) throughput while maintaining proportional fairness across multiple User Equipments (UEs). While examples used herein can describe maximizing a metric (or use other superlatives), it can be appreciated that there can be examples of the present techniques where the metric can be considered to be sufficiently good, though not maximized.

The present techniques can address this problem through employing distributed deep reinforcement learning (DDRL) techniques. In an example, each UE can host a dedicated agent responsible for determining its transmission power (Pᵢ) for PUSCH transmission, ensuring that power allocation can be optimized locally while adhering to global network objectives. A global agent can be implemented at a next-generation NodeB (gNB, sometimes referred to as a base station), which can generate transmission power control (TPC) commands for each distributed UE. These TPC values can provide an upper boundary for the UE agents' transmission power decisions, thereby integrating a layer of centralized control within the distributed framework. The UEs can leverage the received TPC values to fine-tune their Pᵢ decisions, ensuring that power levels can be within a permissible range dictated by the gNB, which can consider holistic network state and performance goals. This approach can maximize individual UE throughput, and also inherently minimize inter-user interference, which can be a common and detrimental issue in dense network environments. The architecture of an example system can be designed to maximize a global reward function that considers the aggregate throughput and incorporates a proportional fairness component through a logarithmic utility function. This can ensure that UEs with a lower throughput can be given due consideration, fostering a balanced and equitable distribution of resources. Additionally, the reward function can penalize constraint violations, such as breaches in Quality of Service (QoS) or power limits, and encourage power efficiency, which can be vital for sustainable network operations.

A state space for the DDRL agents can include local channel conditions, interference levels, historical throughput and power usage, QoS requirements, and/or the accuracy of Channel State Information (CSI). Through a harmonized approach of local observations and actions by UE agents, coupled with global state and reward assessment via a centralized gNB agent, an example system can ensure that the DDRL agents continuously learn and adapt to optimize PUSCH throughput while upholding the principles of proportional fairness. This present techniques can provide a comprehensive and dynamic approach to RAN optimization, leveraging the strengths of both distributed and centralized learning mechanisms. The present techniques can provide an enhancement in network efficiency, robustness, and user satisfaction by judiciously managing the power distribution among UEs and aligning individual actions with collective network performance goals.

In RANs, the optimization of the PUSCH can be a significant challenge, particularly given a need for high throughput and low inter-user interference. Prior approaches often struggle to balance these requirements, especially in dynamic environments with diverse user demands and fluctuating radio conditions. The present techniques can be implemented to facilitate a system that adapts in real-time to optimize PUSCH performance, ensuring efficient power utilization and equitable resource distribution across UEs.

A problem addressed by the preset techniques can be twofold: to maximize the uplink throughput of each individual UE while concurrently minimizing the inter-user interference that can escalate in dense network deployments. It can be that each UE must autonomously determine its transmission power (Pᵢ) for PUSCH transmissions in a manner that can be responsive to the local radio environment and consistent with global network objectives set by the base station.

A complexity of this challenge can arise from a need to make distributed, real-time decisions in a context where individual actions can have far-reaching implications on the network performance. This can prompt an approach that considers the following sub-problems:
1. Local optimization vs. global objectives: Ensuring that the power control decisions made by individual UEs can be both optimal for their specific conditions and conducive to the overall network performance goals.
2. Dynamic environment: Adapting to the rapidly changing radio environment, including variations in channel quality, interference from other UEs, and fluctuating traffic demands.
3. Fairness and efficiency: Balancing throughput maximization with a need for proportional fairness among UEs, preventing scenarios where certain UEs monopolize network resources.

To address this challenge, the present techniques can utilize a distributed deep reinforcement learning (DDRL) framework that features:
1. Distributed agents: Each UE can comprise a dedicated DDRL agent that decides the optimal transmission power (Pᵢ) for PUSCH transmission based on local observations and a learned policy.
2. Global coordination: A central agent at the gNB can generate Transmission Power Control (TPC) commands for each UE, setting a permissible range for their transmission power levels to facilitate alignment with global network objectives.
3. Adaptation mechanism: The UE agents can use the TPC values as a constraint in their optimization process, enabling them to adapt their Pᵢ decisions to the dynamic network conditions, while respecting the limits set by the gNB.
4. Reward function: A global reward function can be employed to guide the DDRL agents, which can consider both the aggregate network throughput and the proportional fairness amongst UEs. This function can include penalties for constraint violations and incentives for power efficiency.
5. Agents training: Agents can be trained by one or more offline servers, prior to deployment. Once trained, distributed agents can then be sent to UEs through an xAP. During an inference mode, each UE can have a chance to update its agent's weights to adapt to changes that were not considered before during the training stage.

In some examples, a DDRL system according to the present techniques can aim to achieve one or more objectives:
Maximize uplink throughput: Enhance the data rates experienced by UEs on the PUSCH.
Minimize inter-user interference: Reduce the negative impact of UEs on other UEs' signal quality, leading to a more stable and reliable network.
Ensure proportional fairness: Distribute network resources in a manner that can be fair and just, giving due attention to UEs with poorer channel conditions.
Adapt to dynamic conditions: Respond effectively to changes in the radio environment, user behavior, and traffic patterns.

The present techniques can address a complex interplay between individual UE performance and network-wide efficiency and fairness. Using a DDRL approach, an example system can be poised to adapt to the evolving network landscape autonomously and continually, paving the way for a more robust and user-centric RAN.

The present techniques can facilitate the following, in contrast to prior approaches:
Distributed deep reinforcement learning (DDRL) integration: A use of DDRL can enable autonomous, real-time optimization of transmission power by each UE while maintaining an overall perspective on network health, and can differ from prior centralized or heuristic-based approaches.
Multiple optimization objectives: There can be a concurrent pursuit of three objectives:
   Maximizing UE throughput.
   Minimizing inter-user interference.
   Enhance global energy consumption policy. This can be achieved by biasing a solution of the global optimization problem into decreasing energy consumption, while ensuring satisfactorily performance. This use of multiple optimization objectives can distinguish the present techniques from prior single-goal optimization models.
Global and local agent system: A deployment of a dual-level agent structure, featuring a central agent at the gNB and localized agents in UEs, can introduce an innovative system that harmonizes centralized guidance with distributed execution.
Proportional fairness in UE performance (reward function): An integration of a logarithmic utility function within a reward scheme to promote proportional fairness among UEs can differ from prior approaches to equitable resource distribution.
Penalties for constraint violations: A reward function that can impose penalties for exceeding operational constraints, such as QoS and power limits.
Comprehensive state space design: The incorporation of a wide-ranging set of state variables into the agents' decision-making process can allow for a more nuanced and responsive optimization system, relative to prior approaches.
Dynamic adaptation mechanism: The capability of a system to adapt transmission power decisions on-the-fly in response to a changing radio environment can differ from prior static, or less adaptive, mechanisms.
Efficiency and fairness balance: An approach to striking a balance between power efficiency and resource distribution fairness can differ from prior approaches.

In sum, the present techniques can deliver a suite of innovative features that collectively establish a new paradigm in the optimization of RAN performance, setting a new benchmark for intelligent and adaptive network management.

A distributed problem formulation can be as follows. The present techniques can facilitate a distributed deep reinforcement learning (DDRL) system that optimizes uplink (UL) PUSCH throughput across multiple UEs in a RAN while ensuring proportional fairness in resource allocation.

### Example Architectures, Etc.

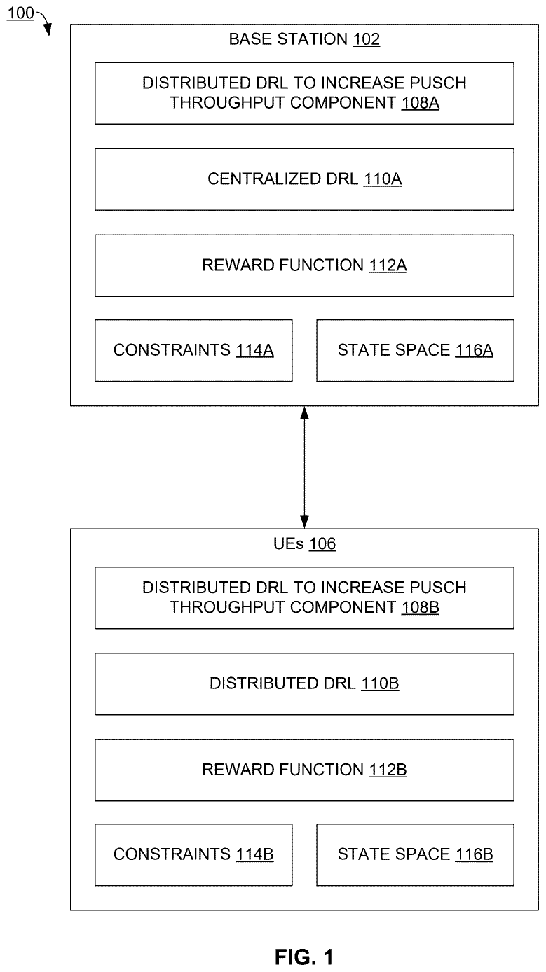

FIG. 1 illustrates an example system architecture 100 that can facilitate distributed DRL to increase PUSCH throughput, in accordance with an embodiment of this disclosure.

System architecture 100 comprises base station 102 and UEs 106. In turn, base station 102 comprises distributed DRL to increase PUSCH throughput component 108A, centralized DRL 110A, reward function 112A, constraints 114A, and state space 116A. And one or more UEs of UEs 106 can comprise distributed DRL to increase PUSCH throughput component 108B, distributed DRL 110B, reward function 112B, constraints 114B, and state space 116B.

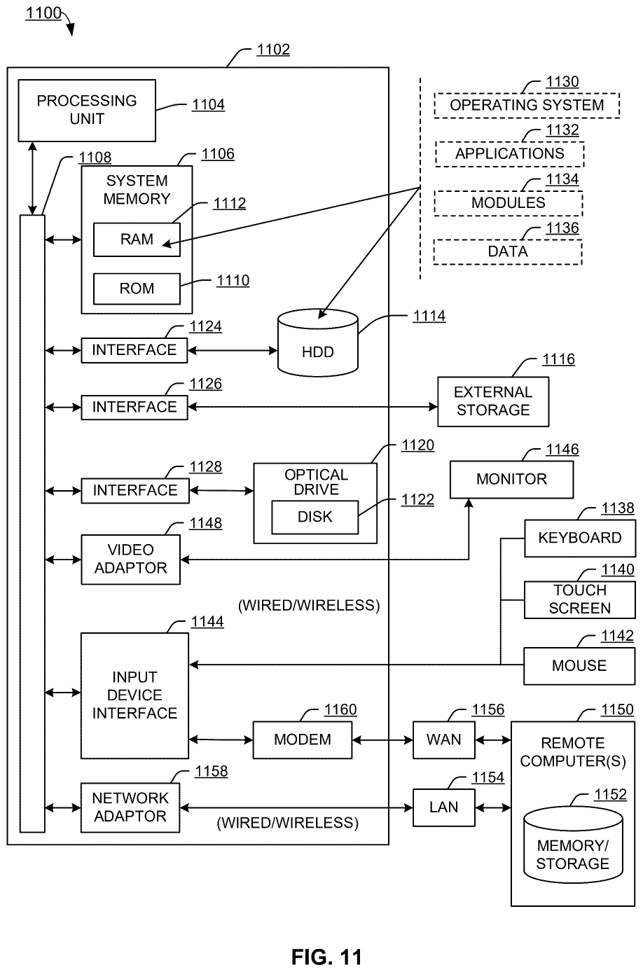

Each of base station 102 and/or UEs 106 can be implemented with part(s) of computing environment 1100 of FIG. 11.

Base station 102 can facilitate broadband cellular network communications with UEs of UEs 106. As part of this, base station 102 can generate Transmission Power Control (TPC) commands for each UE, setting a permissible range for their transmission power levels to facilitate alignment with global network objectives.

This can be effectuated via a dual DRL architecture, where one DRL is centralized DRL 110A at base station 102 and another DRL is distributed DRL 110B (where different instances of distributed DRL 110B can execute on different UEs of UEs 106).

Distributed DRL to increase PUSCH throughput component 108A can facilitate using centralized DRL 110A (which can use reward function 112A, constraints 114A, and state space 116A) to determine TPC commands for the UEs. Additionally, distributed DRL to increase PUSCH throughput component 108A can communicate with instances of distributed DRL to increase PUSCH throughput component 108B (which can use instances of distributed DRL 110B, each of them using instances of reward function 112B, constraints 114B, and state space 116B) in making this determination of TPC commands.

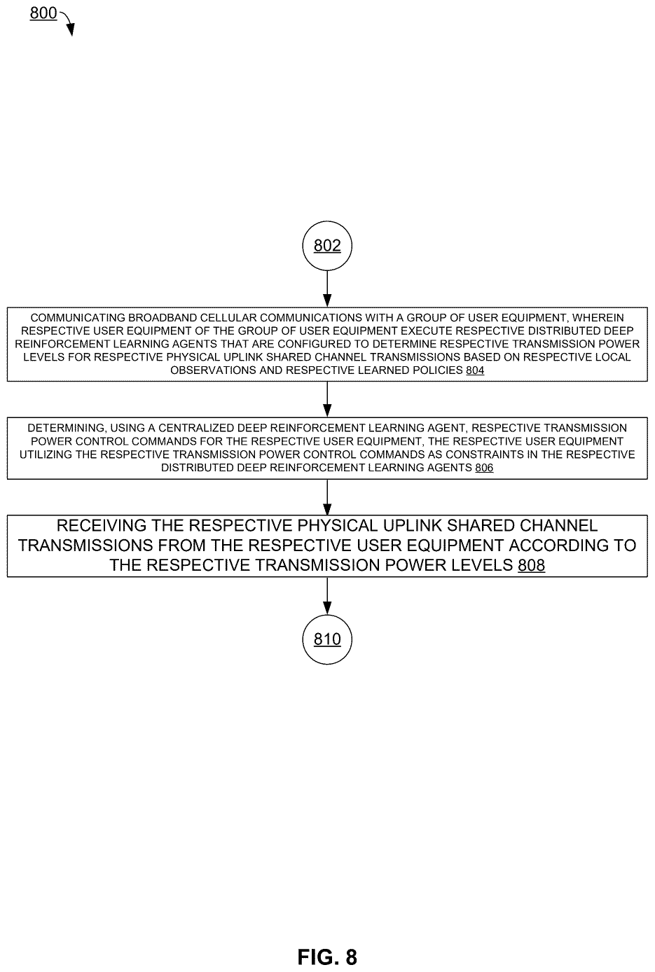

In some examples, distributed DRL to increase PUSCH throughput component 108 can implement part(s) of the process flows of FIGS. 8-10 to facilitate distributed DRL to increase PUSCH throughput.

It can be appreciated that system architecture 100 is one example system architecture for distributed DRL to increase PUSCH throughput, and that there can be other system architectures that facilitate distributed DRL to increase PUSCH throughput.

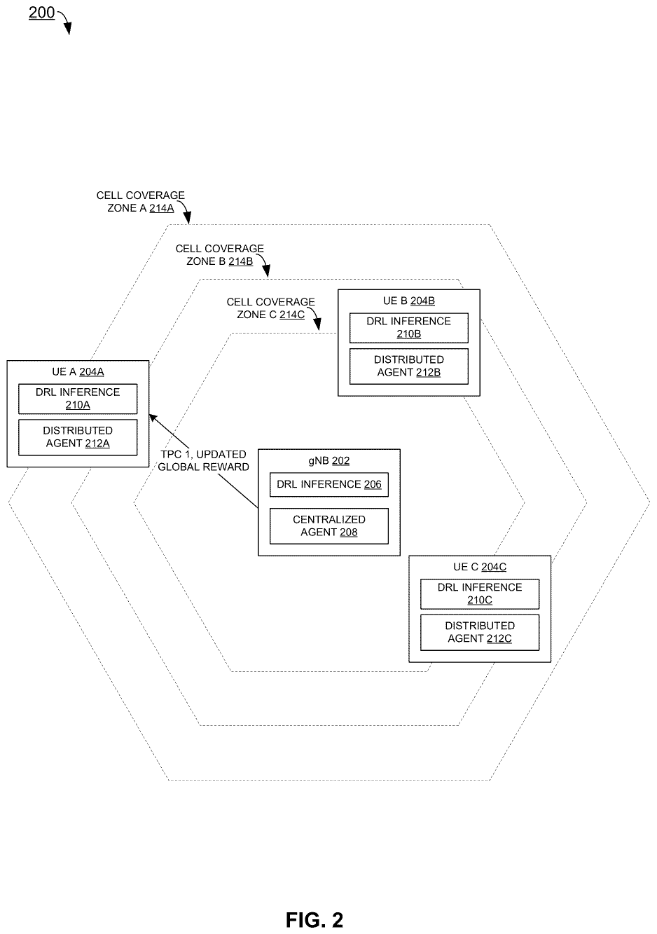

FIG. 2 illustrates another example system architecture 200 that can facilitate distributed DRL to increase PUSCH throughput, in accordance with an embodiment of this disclosure. In some examples, part(s) of system architecture 200 can be implemented by part(s) of system architecture 100 of FIG. 1 to facilitate distributed DRL to increase PUSCH throughput.

System architecture 200 comprises gNB 202, UE A 204A, UE B 204 B, UE C 204C, DRL inference 206, centralized agent 208, DRL inference 210A, DRL inference 210B, DRL inference 210C, distributed agent 212A, distributed agent 212B, distributed agent 212C, cell coverage zone A 214A, cell coverage zone B 214B, and cell coverage zone C 214C.

In system architecture 200, a dual DRL architecture of centralized agent 208 on gNB 202, and a DRL inference on UEs (distributed agent 212A, distributed agent 212B, and distributed agent 212C on UE A 204A, UE B 204 B, and UE C 204C, respectively) can facilitate distributed DRL to increase PUSCH throughput.

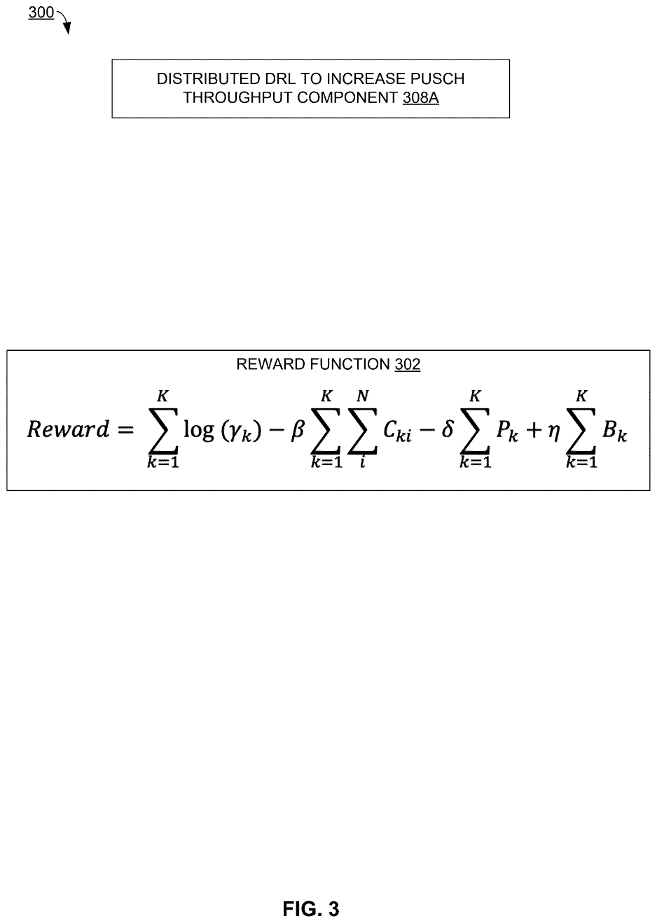

FIG. 3 illustrates an example 300 of a reward function, and that can facilitate distributed DRL to increase PUSCH throughput, in accordance with an embodiment of this disclosure. In some examples, part(s) of example 300 can be implemented by part(s) of system architecture 100 of FIG. 1 to facilitate distributed DRL to increase PUSCH throughput.

Example 300 comprises reward function 302 and distributed DRL to increase PUSCH throughput component 308A (which can be similar to distributed DRL to increase PUSCH throughput component 108A of FIG. 1).

A global reward function according to the present techniques can be defined as:

$$Reward = {\sum }_{k = 1}^{K} log ( {γ}_{k} ) - β {\sum }_{k = 1}^{K} {\sum }_{i}^{N} {C}_{ki} - δ {\sum }_{k = 1}^{K} {P}_{k} + η {\sum }_{k = 1}^{K} {B}_{k}$$

Where:
γₖ: represents a UL signal to noise ratio (SINR) (in ratio) value of the k^{th} UE, which logarithmically promotes proportional fairness.
Cₖᵢ: represents a penalty for violating the i^{th} constraint of the k^{th} UE (e.g., QoS requirements or upper and lower power limits).
Pₖ: represents the power consumed for the i^{th} UE during the previous allocation round. The agents can try to minimize this term.
β, δ, with β+δ+η=1: represent weighting factors to balance constraint satisfaction and power efficiency.
Bₖ: represents the battery life of the k^{th} UE.
N: represents the total number of performance constraints per UE.

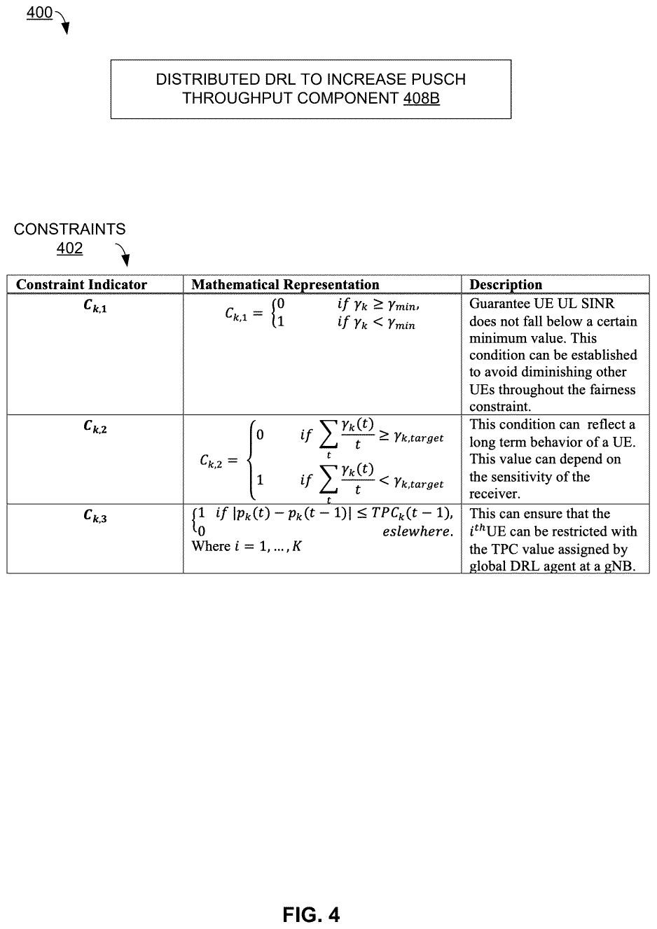

FIG. 4 illustrates an example 400 of UE constraints, and that can facilitate distributed DRL to increase PUSCH throughput, in accordance with an embodiment of this disclosure. In some examples, part(s) of example 400 can be implemented by part(s) of system architecture 100 of FIG. 1 to facilitate distributed DRL to increase PUSCH throughput.

Example 400 comprises UE constraints 402 and distributed DRL to increase PUSCH throughput component 408B (which can be similar to distributed DRL to increase PUSCH throughput component 108B of FIG. 1).

Example 400 illustrates an example set of constraints that can be implemented per UE.

| Constraint | | |
|---|---|---|
| Indicator | Mathematical Representation | Description |
| C_{k,1} | ${C}_{k , 1} = \{ \begin{matrix}0 & if {γ}_{k} \geq {γ}_{min} \\ 1 & if {γ}_{k} < {γ}_{min}\end{matrix} ,$ | Guarantee UE UL SINR does not fall |
| | | below a certain |
| | | minimum value. This |
| | | condition can be |
| | | established to avoid |
| | | diminishing other |
| | | UEs throughout the |
| | | fairness constraint. |
| C_{k,2} | ${C}_{k , 2} = \{ \begin{matrix}0 & if {\sum }_{t} \frac{{γ}_{k} ( t )}{t} \geq {γ}_{k , target} \\ 1 & if {\sum }_{t} \frac{{γ}_{k} ( t )}{t} < {γ}_{k , target}\end{matrix}$ | This condition can reflect a long term behavior of a UE. This value can depend on the |
| | | sensitivity of the |
| | | receiver. |
| C_{k,3} | $\{ \begin{matrix}1 & if \vert {p}_{k} ( t ) - {p}_{k} ( t - 1 ) \vert \leq {TPC}_{k} ( t - 1 ) , \\ 0 & elsewhere\end{matrix} .$ | This can ensure that the i^{th} UE can be |
| | Where i = 1, ... , K | restricted with the |
| | | TPC value assigned |
| | | by global DRL agent |
| | | at a gNB. |

An action space can be as follows. In some examples, two sets of UE-related actions can be implemented:

TPC commands (centralized, discrete action): This action domain can be taken from a global DRL agent located at a gNB, where TPCₖϵ{−1 dB, 0 dB, +1 dB, +3 dB}, and where measurements are in decibels (dB).

Transmit power levels (distributed, continuous action): This action can include a best Pₖ value, and can be taken according to the given TPCₖ based on the following criterion (for each UE):

A gNB agent sends an optimized TPCₖ to the k^{th} UE.

Along with other input state parameters, the k^{th} UE can then optimize it transmission power value (denoted by Pₖ within the range allowed by TPCₖ.

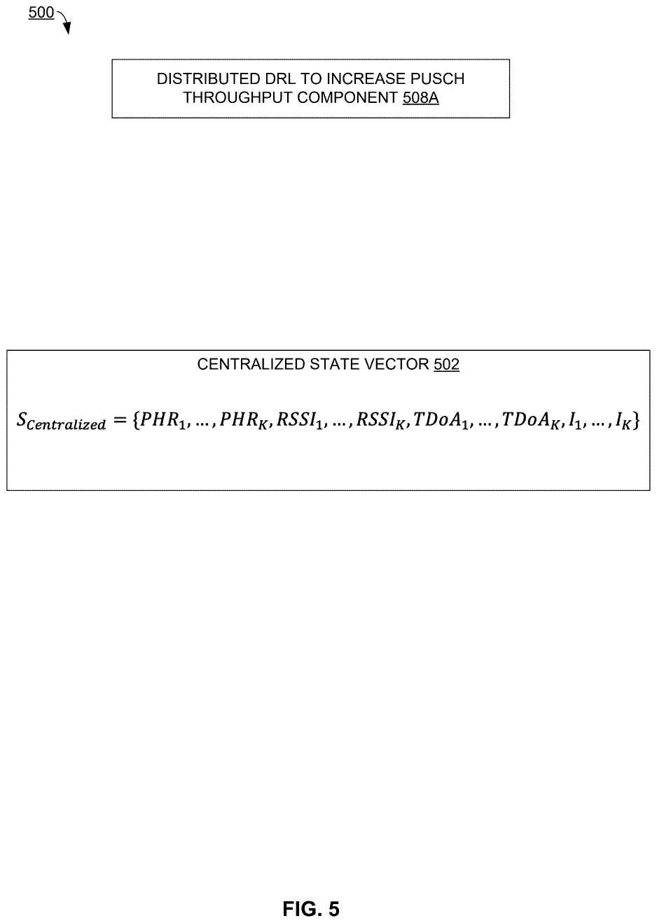

FIG. 5 illustrates an example 500 of a state vector for a centralized DRL, and that can facilitate distributed DRL to increase PUSCH throughput, in accordance with an embodiment of this disclosure. In some examples, part(s) of example 500 can be implemented by part(s) of system architecture 100 of FIG. 1 to facilitate distributed DRL to increase PUSCH throughput.

A state space can be as follows.

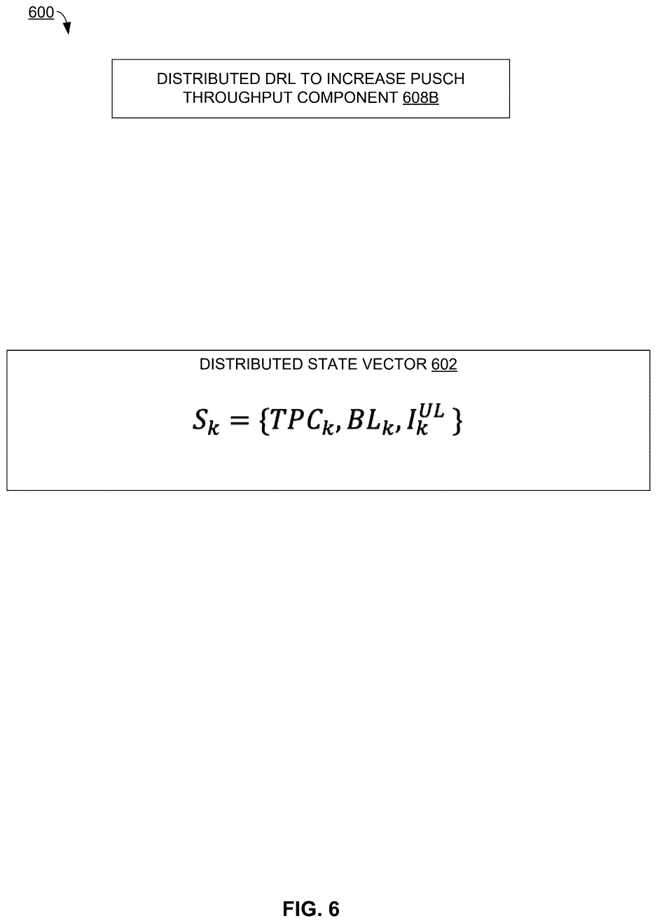

In some examples, there can be two sets of state vectors, one for the centralized DRL system, and another for each distributed DRL system (as described with respect to FIG. 6).

Example 500 comprises centralized state vector 502 and distributed DRL to increase PUSCH throughput component 508A (which can be similar to distributed DRL to increase PUSCH throughput component 108A of FIG. 1).

State vector for centralized DRL: For a centralized DRL system at a gNB, the state vector can be:

$${S}_{Centralized} = \{ {PHR}_{1} , … , {PHR}_{K} , {RSSI}_{1} , … , {RSSI}_{K} , {TDoA}_{1} , … , {TDoA}_{K} , {I}_{1} , … , {I}_{K} \}$$

Where,
PHRₖ: represents the power headroom reported by the k^{th} UE.
RSSIₖ: represents the received signal strength indicator of the k^{th} UE.
TDoAₖ: represents the time difference of arrival for the k^{th} UE.
Iₖ: represents the level of interference on the k^{th} UE, caused by other UEs.

FIG. 6 illustrates an example 600 of a state vector for a distributed DRL, and that can facilitate distributed DRL to increase PUSCH throughput, in accordance with an embodiment of this disclosure. In some examples, part(s) of example 600 can be implemented by part(s) of system architecture 100 of FIG. 1 to facilitate distributed DRL to increase PUSCH throughput.

Example 600 comprises distributed state vector 602 and distributed DRL to increase PUSCH throughput component 608B (which can be similar to distributed DRL to increase PUSCH throughput component 108B of FIG. 1).

State vector for distributed DRL: The following state vector can be used at the input of distributed DRL system at the k^{th} UE.

$${S}_{k} = \{ {TPC}_{k} , {BL}_{k} , {I}_{k}^{UL} \}$$

Where,
TPCₖ: represents be the previous TPC value of the k^{th} UE, reported by gNB.
BLₖ: represents be the battery level of the k^{th} UE (accessible by the UE itself).

$${I}_{k}^{UL} :$$

represents the UL interference levels caused on the k^{th} UE, reported by gNB.

Distributed DRL training and inference can be implemented as follows. In a DDRL implementation according to the present techniques, each UE can be represented by an agent that operates within a shared RAN environment. The agents can learn collaboratively to maximize a global reward function. The learning process and feedback mechanisms can be as follows:

Local observation and action:
Observation: Each agent (within each UE) can observe its local state, which can include parameters such as signal strength, interference levels, and current power settings.
Action selection: Each agent can select an action from its hybrid action space. For UE agents, this action space can involve selecting the transmission power level Pₖ. For the gNB agent, the action space can include transmission power control (TPC) commands represented as [TPC₁, TPC₂, . . . , TPC_{K}], where K can be the overall number of UEs.

Global state and reward:
Global state: Actions taken by all UEs and the gNB can impact the global state space, which can include aggregated network performance metrics such as overall interference, throughput, and fairness indices.
Global reward determination: The global reward function can be determined based on the global state. This function can incentivize actions that improve both individual UE performance and overall network efficiency. Factors such as achieved data rates, power efficiency, and minimized interference can be considered in the reward function.

Policy update:
Shared reward signal: Agents can receive a shared reward signal derived from the global reward function. This signal can promote actions that contribute positively to both individual and collective outcomes.
Policy update algorithms: The policies of the agents can be updated using reinforcement learning approaches that suited for distributed environments:
   Proximal policy optimization (PPO): PPO can be used for its stability and effectiveness in handling continuous action spaces. It can ensure that policy updates can be made conservatively to prevent large deviations that could destabilize learning.
   Deep deterministic policy gradient (DDPG): DDPG can be employed for scenarios requiring precise control over continuous action spaces, leveraging off-policy learning to improve sample efficiency.

DDRL agent types:
Local agents: These agents can be implemented on UEs and focus on optimizing individual performance metrics, such as transmission power and data rate.
Global agent: This agent can be located at the gNB and ensure that the collective actions of UEs align with network-wide optimization goals. The global agent can oversee the coordination and synchronization of local agents.

Activation functions: The neural networks within the DDRL agents can utilize activation functions for their tasks:
Hidden layers: Rectified Linear Units (ReLU) can be used for hidden layers due to their efficiency and capability to mitigate the vanishing gradient problem.
Output layer: In some examples, depending on the action space specifics, the output layer can use a sigmoid or softmax function to produce bounded and probabilistic outputs, respectively.

Synchronization and communication:
Periodic synchronization: Local agents can periodically synchronize with the global agent to ensure their policies remain aligned with the dynamically changing network objectives. This synchronization can help in maintaining coherence across a distributed learning process.
Communication interface: A low-latency, high-reliability communication interface between the UEs and the gNB can be implemented. This interface can facilitate a timely exchange of observations, actions, and TPC commands, ensuring that the distributed learning process remains effective and responsive to network conditions.

Scalability of an example system according to the present techniques can be implemented as follows. The DDRL system can be designed to be scalable, allowing for the seamless addition of more UEs without significantly increasing computational complexity at the gNB. This scalability can be achieved through efficient policy update mechanisms and optimized communication protocols.

An example DDRL scheme can leverage advanced reinforcement learning techniques to enable UEs to learn collaboratively within a shared RAN environment. By focusing on global optimization through coordinated power control and policy updates, the system can ensure improved network performance and fairness among UEs. In some examples, a use of PPO and DDPG approaches, along with efficient synchronization and communication strategies, can underpin effectiveness and scalability of the DDRL scheme.

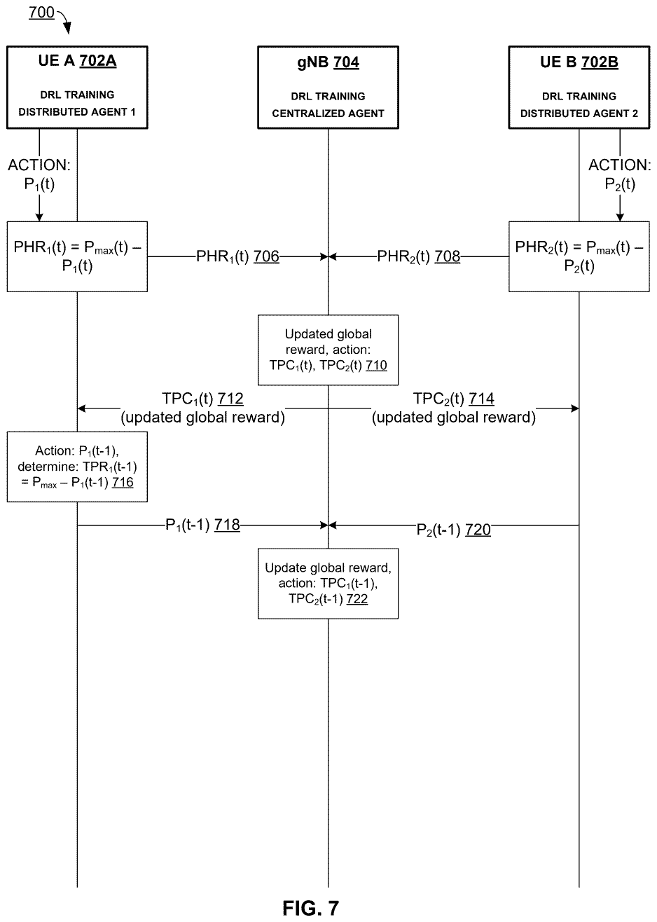

FIG. 7 illustrates an example signal flow 700 for training in a two UE scenario, and that can facilitate distributed DRL to increase PUSCH throughput, in accordance with an embodiment of this disclosure. In some examples, part(s) of signal flow 700 can be implemented by part(s) of system architecture 100 of FIG. 1 to facilitate distributed DRL to increase PUSCH throughput.

The signals of signal flow 700 occur between UE A 702A, UE B 702B, and gNB 704. These signals are:
PHR₁(t) 706;
PHR₂(t) 708;
Updated global reward, action: TPC₁(t), TPC₂(t) 710;
TPC₁(t) 712 (updated global reward);
TPC₂(t) 714 (updated global reward);
Action: P₁(t−1), determine: TPR₁(t−1)=Pₘₐₓ−P₁(t−1) 716;
P₁(t−1) 718;
P₂(t−1) 720; and
Update global reward, action: TPC₁(t−1), TPC₂(t−1) 722.

The following can be implemented as part of training in a 2 UE scenario.

Interaction with environment:
Observation:
   Centralized DRL agent: Observes the centralized state vector SCentralized S_{centralized}, which can include power headroom, RSSI, TDoA, and interference levels for all UEs.
   Distributed DRL agents (UEs): Each UE can observe its respective state vector Sk, which can include its previous TPC value, battery level, and UL interference levels.
Action Selection:
   Centralized DRL Agent: Selects TPC commands TPCₖ for each UE based on the observed centralized state S_{centralized}. The TPC commands can be chosen from the discrete set {−1 dB, 0 dB, +1 dB, +3 dB}.
   Distributed DRL Agents (UEs): Each UE k selects an optimal transmission power Pₖ within the range allowed by TPCₖ based on its observed state Sₖ. Policy Evaluation:
Reward Determination: The reward function R can be computed to reflect the system's performance. This can include terms for UL SINR (γₖ), penalties for constraint violations (Cₖᵢ), power consumption (Pₖ), and battery life (Bₖ):
Trajectory storage: Store the state-action-reward sequences for each time step and each agent (centralized and distributed). This data can be essential for updating the policies through DRL algorithms.

Policy Improvement:
Centralized DRL Agent: Update the policy parameters to maximize the global reward using DRL techniques such as Proximal Policy Optimization (PPO), Deep Q-Networks (DQN), or Actor-Critic methods. Perform gradient descent or other optimization methods to adjust the policy parameters based on the observed rewards and stored trajectories.
Distributed DRL agents (UEs): Each UE can update its policy to optimize its transmission power Pₖ using localized DRL techniques. This can involve adjusting the policy parameters based on the local state Sₖ and the computed reward.

Value Function Update:
Centralized DRL agent: Use value-based techniques like Q-learning or policy-based methods like PPO to update the value function, which can estimate the expected reward for the centralized state-action pairs.
Distributed DRL agents (UEs): Each UE can apply similar value-based or policy-based methods to update its value function, estimating the expected reward for its local state-action pairs.

Exploration vs. Exploitation
Centralized DRL Agent:
   Exploration:
      Implement an EE-greedy strategy, where EE decays over time to shift from exploration to exploitation.
      Use techniques like Thompson Sampling or upper confidence bound (UCB) to balance exploration and exploitation.
   Exploitation: Focus on exploiting the learned policy to select TPC commands that maximize the expected reward as EE decreases.
Distributed DRL agents (UEs):
   Exploration: Each UE can use EE-greedy or noise injection methods (e.g., adding Gaussian noise to actions) during training to explore various power levels.
   Exploitation: Gradually rely more on the learned policy to select optimal transmission power levels, focusing on maximizing the local and global reward.

System integration can be implemented as follows.
Initialization:
   Initialize both the centralized DRL agent and distributed DRL agents with random or pre-trained policies.
   Set initial state vectors SCentralized and Sₖ based on real-time measurements from UEs and a gNB.
Training Phase:
   Episode Execution:
      Run multiple episodes, each comprising multiple time steps.
      At each time step, the centralized agent can select TPC commands, and each UE can select its transmission power.
      Determine the reward R and store the state-action-reward sequences.
   Policy update:
      Use DRL techniques like PPO, DQN, or Actor-Critic to update both centralized and distributed policies.
      Perform optimization steps to adjust policy.
Evaluation Phase:
   Performance testing:
      After training, evaluate the DDRL system's performance in a controlled RAN environment, either through simulation or a testbed.
      Monitor key performance indicators (KPIs) such as UL PUSCH throughput, SINR, power consumption, and battery life.
   Comparison with baseline:
      Compare the DDRL system's performance against baseline approaches (e.g., traditional TPC algorithms) to quantify improvements.
      Perform statistical analysis to ensure the observed improvements can be significant and consistent.
   Stress testing: Test the DDRL system under various network conditions, including high interference scenarios, varying UE mobility patterns, and different traffic loads, to ensure robustness and adaptability.

A complexity analysis for the present techniques can be as follows.

The computational complexity of a DDRL system can be influenced by the number of UEs in the system, denoted as K, and the dimensionality of the state spaces for both the centralized agent at the gNB and the distributed agents at each UE.

A centralized agent's complexity can depend on the dimensionality of its state space, which can aggregate global information from all UEs. The dimensionality of the centralized state space can be denoted as D_{c}. The complexity of processing this state space can depend on the neural network architecture used by the central agent. If a fully connected neural network can be used, and assuming L layers with N neurons each, the computational complexity can be O(L* [symbol] ²) for feedforward operations at each time step. However, where the state information from K UEs can be aggregated, the input layer's size can scale with K, leading to an input layer complexity of O(K* [symbol] ). Subsequent layers can follow the O(L* [symbol] ²) complexity where they remain constant in size.

For distributed agents, each agent can observe its local environment and have a lower-dimensional state space compared to the centralized agent. The dimensionality of each distributed agent's state space can be denoted as D_{d}. Given K agents, the complexity can be K times the complexity of a single agent's operations. Assuming a similar neural network architecture for the local agents as the central agent, the complexity per agent can be expressed as O(L* [symbol] ²) and the total complexity for all distributed agents can be expressed as O(K*L* [symbol] ²).

Communication complexity can involve the amount of data exchanged between the centralized agent and the distributed agents. It can be that each UE agent periodically sends its local observations to the gNB and receives updated policies or TPC commands. The amount of data sent per UE can be proportional to D_{d}, and the amount of data received can be related to the size of the action space, which can be denoted as A. Therefore, for K UEs, the communication complexity can be expressed as O(K*(Dd+A)) per time step.

Learning complexity can pertain to the training of the DDRL models. This can involve backpropagation through neural networks and policy updates. The complexity of backpropagation can be generally on the same order as feedforward operations, and can be considered to be O(L* [symbol] ²) for each agent. However, it can be that training occurs less frequently than inference (decision-making), and it can often be performed asynchronously and in parallel, reducing the real-time computational burden.

The overall complexity of the DDRL system for PUSCH optimization can be summarized as follows:
Centralized agent: O(K*N+L* [symbol] ²) per time step for inference.
Distributed agents: O(K*L* [symbol] ²) per time step for inference.
Communication: O(K*(Dd+A)) per time step.
Learning: Generally, O(L* [symbol] ²) for each agent, but it can be that, with parallel and asynchronous execution, this does not directly scale with K.

For the DDRL system to be scalable, it can be that it must manage the increase in K without a linear increase in computational resources. Techniques such as parameter sharing among distributed agents, reducing the communication frequency, and employing model compression or scarification can help to manage the complexity as K grows.

The present techniques can be implemented to provide some or all of the following benefits:
Enhanced network efficiency: The present techniques can enable a network to dynamically adjust to varying conditions in real-time, optimizing the allocation of resources and power control to improve the overall efficiency of the network. This level of optimization can be unattainable with prior approaches, particularly in highly dynamic and dense network scenarios where user demands and interference patterns constantly change.
Scalability: As the number of UEs increases, the complexity of network management can escalate. An example DDRL system according to the present techniques can be designed to handle this scalability challenge, allowing for the efficient management of thousands of UEs. The ability to scale can be used for future-proofing the network against growing demands for connectivity.
Adaptability and autonomy: An example DDRL system according to the present techniques can be capable of adapting to unforeseen scenarios without human intervention, learning from the environment, and improving its decision-making processes over time. This adaptability can be used for maintaining high levels of service quality in a landscape where user behavior and network conditions can be unpredictable.
Quality of service (QoS) enhancement: By optimizing PUSCH, an example DDRL system according to the present techniques can ensure better QoS for end-users. It can intelligently manage uplink traffic, which can be critical for applications requiring low latency and high reliability, such as augmented reality (AR), virtual reality (VR), and the Internet of Things (IoT).
Resource utilization: An example DDRL system according to the present techniques can make optimal use of available spectral resources, reducing wastage and increasing the capacity of the network. This can be valuable given the finite nature of the radio spectrum and the economic and regulatory challenges associated with acquiring more bandwidth.
Future readiness: With the advent of 5G and the movement towards 6G and beyond, it can be that network complexity will continue to grow. A DDRL approach according to the present techniques can position the network to handle this increasing complexity, setting a foundation for integrating more advanced technologies and accommodating emerging use cases.
Cost-effectiveness: An example DDRL system according to the present techniques can offer long-term cost savings through reduced manual interventions, optimized maintenance, and efficient use of resources.

### Example Process Flows

FIG. 8 illustrates an example process flow 800 that can facilitate distributed DRL to increase PUSCH throughput, in accordance with an embodiment of this disclosure. In some examples, one or more embodiments of process flow 800 can be implemented by system architecture 100 of FIG. 1, or computing environment 1100 of FIG. 11.

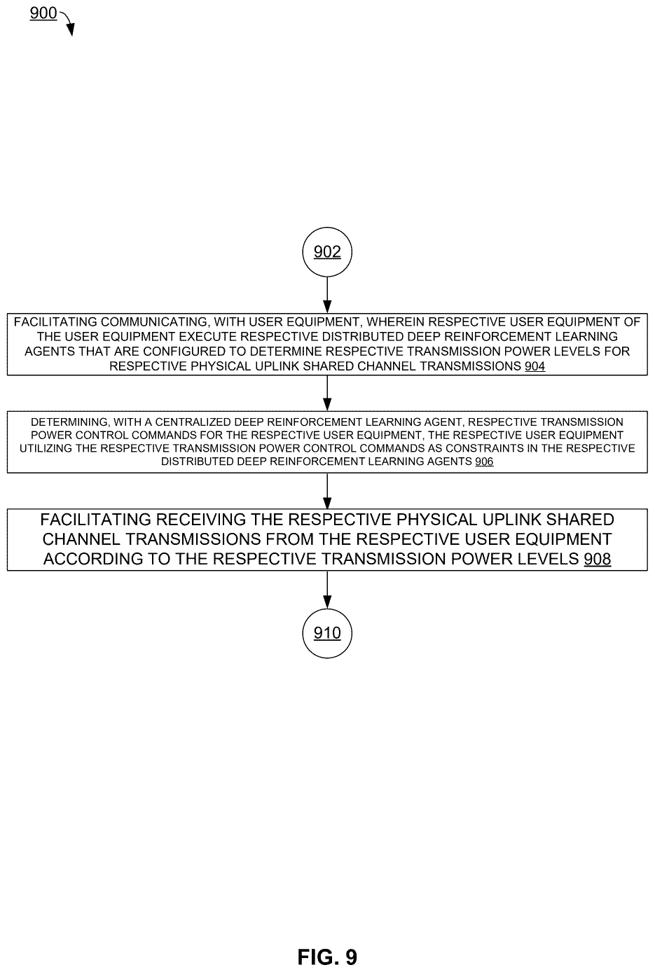

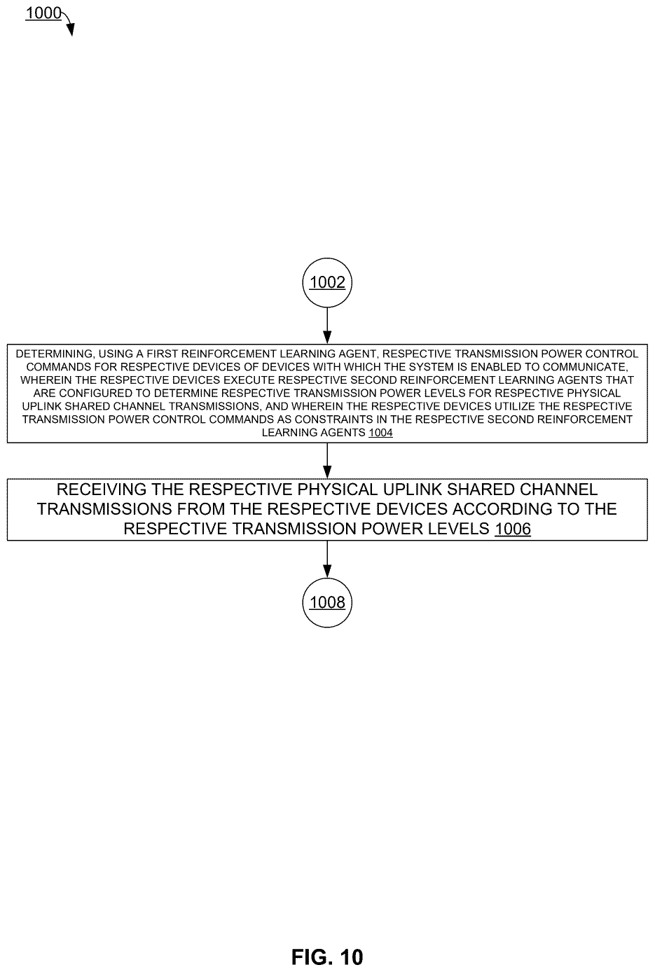

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 900 of FIG. 9, and/or process flow 1000 of FIG. 10.

Process flow 800 begins with 802, and moves to operation 804.

Operation 804 depicts communicating broadband cellular communications with a group of user equipment, wherein respective user equipment of the group of user equipment execute respective distributed deep reinforcement learning agents that are configured to determine respective transmission power levels for respective physical uplink shared channel transmissions based on respective local observations and respective learned policies. That is, using the example of FIG. 1, base station 102 can facilitate broadband cellular communications with UEs 106, where the UEs execute instances of distributed DRL 110B.

In some examples, the respective distributed deep reinforcement learning agents are trained offline, and wherein the respective distributed deep reinforcement learning agents are deployed to the respective user equipment via respective xAPs. In some examples, the respective user equipment are configured to update respective weights of the respective distributed deep reinforcement learning agents after the respective distributed deep reinforcement learning agents have been deployed to the respective user equipment. That is, agents can be trained by one or more offline servers, prior to deployment. Once trained, distributed agents can then be sent to UEs through an xAP. During an inference mode, each UE can have a chance to update its agent's weights to adapt to changes that were not considered before during the training stage.

After operation 804, process flow 800 moves to operation 806.

Operation 806 depicts determining, using a centralized deep reinforcement learning agent, respective transmission power control commands for the respective user equipment, the respective user equipment utilizing the respective transmission power control commands as constraints in the respective distributed deep reinforcement learning agents. Continuing with the example of FIG. 1, the centralized deep reinforcement learning agent can be centralized DRL 110A.

In some examples, the respective transmission power control commands identify respective permissible ranges of transmission power levels for the respective transmission power levels. In some examples, the respective transmission power control commands are drawn from a discrete set of power levels. That is, the base station can generate TPC commands for each UE, where the TPC commands set a permissible range for the UE's transmission power levels (such as to ensure alignment with global network objectives). The discrete set of power levels can be, for example, {−1 dB, 0 dB, +1 dB, +3 dB}.

In some examples, the centralized deep reinforcement learning agent applies a reward function that is based on an aggregate throughput of the broadband cellular communications, and is based on a criterion usable to determine proportional fairness among the respective user equipment. In some examples, the reward function is further based on a penalty for constraint violations, and an incentive to increase power efficiency according to a defined efficiency criterion. This can be a global reward function, as described herein.

After operation 806, process flow 800 moves to operation 808.

Operation 808 depicts receiving the respective physical uplink shared channel transmissions from the respective user equipment according to the respective transmission power levels.

After operation 808, process flow 800 moves to 810, where process flow 800 ends.

FIG. 9 illustrates another example process flow 900 that can facilitate distributed DRL to increase PUSCH throughput, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 800 of FIG. 8, and/or process flow 1000 of FIG. 10.

Process flow 900 begins with 902, and moves to operation 904.

Operation 904 depicts facilitating communicating, with user equipment, wherein respective user equipment of the user equipment execute respective distributed deep reinforcement learning agents that are configured to determine respective transmission power levels for respective physical uplink shared channel transmissions. In some examples, operation 904 can be implemented in a similar manner as operation 804 of FIG. 8.

In some examples, a state space of a first decentralized deep reinforcement learning agent of the decentralized deep reinforcement learning agents of a first user equipment of the user equipment comprises a previous transmission power control value of the first user equipment, a battery level of the first user equipment, and an interference level caused by the first user equipment. This state space can be

$${S}_{k} = \{ {TPC}_{k} , {BL}_{k} , {I}_{k}^{UL} \} .$$

In some examples, the respective distributed deep reinforcement learning agents are configured to determine the respective transmission power levels for the respective physical uplink shared channel transmissions based on respective policies, and wherein the respective policies are updated based on a proximal policy optimization technique, based on a deep deterministic policy gradient technique, based on a deep-Q network technique, or based on an actor-critic technique. That is, policies of agents can be updated using techniques such as PPO, DDPG, DQN, or actor-critic techniques.

After operation 904, process flow 900 moves to operation 906.

Operation 906 depicts determining, with a centralized deep reinforcement learning agent, respective transmission power control commands for the respective user equipment, the respective user equipment utilizing the respective transmission power control commands as constraints in the respective distributed deep reinforcement learning agents. In some examples, operation 906 can be implemented in a similar manner as operation 806 of FIG. 8.

In some examples, the centralized deep reinforcement learning agent comprises a reward function that is based on at least respective logarithms of respective uplink signal-to-noise-ratios of the respective user equipment. That is, the reward function can comprise γₖ, which can represent a UL signal to noise ratio (SINR) (in ratio) value of the k^{th} UE, which can logarithmically promote proportional fairness.

In some examples, a constraint of the centralized deep reinforcement learning agent comprises respective power headrooms of the respective user equipment, respective received signal strength indicators of the respective user equipment, respective time difference of arrival values of the respective user equipment, or respective levels of interference of the respective user equipment.

In some examples, a state space of the centralized deep reinforcement learning agent comprises respective power headrooms of the respective user equipment, respective received signal strength indicators of the respective user equipment, respective time difference of arrival values of the respective user equipment, and respective levels of interference of the respective user equipment. This state space can be S_{Centralized}={PHR₁, . . . , PHR_{K}, RSSI₁, . . . , RSSI_{K}, TDoA₁, . . . , TDoA_{K}, I₁, . . . , I_{K}}.

In some examples, the centralized deep reinforcement learning agent comprises hidden layer and an output layer, wherein the hidden layer comprises a group of rectified linear units, and wherein the output layer comprises a sigmoid function or a softmax function. That is, a DRL agent can comprise hidden layers and an output layer as described herein.

After operation 906, process flow 900 moves to operation 908.

Operation 908 depicts facilitating receiving the respective physical uplink shared channel transmissions from the respective user equipment according to the respective transmission power levels. In some examples, operation 908 can be implemented in a similar manner as operation 808 of FIG. 8.

After operation 908, process flow 900 moves to 910, where process flow 900 ends.

FIG. 10 illustrates another example process flow 1000 that can facilitate distributed DRL to increase PUSCH throughput, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow 800 of FIG. 8, and/or process flow 900 of FIG. 9.

Process flow 1000 begins with 1002, and moves to operation 1004.

Operation 1004 depicts determining, using a first reinforcement learning agent, respective transmission power control commands for respective devices of devices with which the system is enabled to communicate, wherein the respective devices execute respective second reinforcement learning agents that are configured to determine respective transmission power levels for respective physical uplink shared channel transmissions, and wherein the respective devices utilize the respective transmission power control commands as constraints in the respective second reinforcement learning agents. In some examples, operation 1004 can be implemented in a similar manner as operations 804-806 of FIG. 8.

In some examples, the respective second reinforcement learning agents are configured to determine the respective transmission power levels for the respective physical uplink shared channel transmissions based on respective policies, operation 1004 comprises periodically sending, to the respective second reinforcement learning agents, updates to the respective policies, based on the respective second reinforcement learning agents synchronizing with the first reinforcement learning agent. This can be periodic synchronization for policy alignment as described herein.

In some examples, operation 1004 comprises storing respective first state-action-reward sequences of the first reinforcement learning agent for respective time steps, and storing respective second state-action-reward sequences of the respective second reinforcement learning agents for the respective time steps.

In some examples, the respective first reinforcement learning agents are configured to determine the respective transmission power levels for the respective physical uplink shared channel transmissions based on respective policies, and operation 1004 comprises adjusting respective parameters of the respective policies based on the respective first state-action-reward sequences, and based on the respective second state-action-reward sequences.

That is, state-action-reward sequences can be stored for each step and each agent (centralized and distributed). This information can then be used to update policies.

In some examples, the first reinforcement learning agent implements an epsilon-greedy technique, a Thompson sampling technique, or an upper-confidence-bound technique during an exploration phase.

In some examples, the respective second reinforcement learning agents implement an epsilon-greedy technique or a noise-injection technique during respective exploration phases. That is, an exploration phase of both the centralized DRL agent and the distributed DRL agents can be implemented as described herein.

After operation 1004, process flow 1000 moves to operation 1006.

Operation 1006 depicts receiving the respective physical uplink shared channel transmissions from the respective devices according to the respective transmission power levels. In some examples, operation 1006 can be implemented in a similar manner as operation 808 of FIG. 8.

After operation 1006, process flow 1000 moves to 1008, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of base station 102 and/or UEs 106 of FIG. 1.

In some examples, computing environment 1100 can implement one or more embodiments of the process flows of FIGS. 8-10 to facilitate distributed DRL to increase PUSCH throughput.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
communicating broadband cellular communications with a group of user equipment, wherein respective user equipment of the group of user equipment execute respective distributed deep reinforcement learning agents that are configured to determine respective transmission power levels for respective physical uplink shared channel transmissions based on respective local observations and respective learned policies;
determining, using a centralized deep reinforcement learning agent, respective transmission power control commands for the respective user equipment, the respective user equipment utilizing the respective transmission power control commands as constraints in the respective distributed deep reinforcement learning agents; and
receiving the respective physical uplink shared channel transmissions from the respective user equipment according to the respective transmission power levels.

2. The system of claim 1, wherein the respective transmission power control commands identify respective permissible ranges of transmission power levels for the respective transmission power levels.

3. The system of claim 2, wherein the respective transmission power control commands are drawn from a discrete set of power levels.

4. The system of claim 1, wherein the centralized deep reinforcement learning agent applies a reward function that is based on an aggregate throughput of the broadband cellular communications, and is based on a criterion usable to determine proportional fairness among the respective user equipment.

5. The system of claim 4, wherein the reward function is further based on a penalty for constraint violations, and an incentive to increase power efficiency according to a defined efficiency criterion.

6. The system of claim 1, wherein the respective distributed deep reinforcement learning agents are trained offline, and wherein the respective distributed deep reinforcement learning agents are deployed to the respective user equipment via respective xAPs.

7. The system of claim 1, wherein the respective user equipment are configured to update respective weights of the respective distributed deep reinforcement learning agents after the respective distributed deep reinforcement learning agents have been deployed to the respective user equipment.

8. A method, comprising:
facilitating, by a system comprising at least one processor, communicating, with user equipment, wherein respective user equipment of the user equipment execute respective distributed deep reinforcement learning agents that are configured to determine respective transmission power levels for respective physical uplink shared channel transmissions;
determining, with a centralized deep reinforcement learning agent of the system, respective transmission power control commands for the respective user equipment, the respective user equipment utilizing the respective transmission power control commands as constraints in the respective distributed deep reinforcement learning agents; and
facilitating, by the system, receiving the respective physical uplink shared channel transmissions from the respective user equipment according to the respective transmission power levels.

9. The method of claim 8, wherein the centralized deep reinforcement learning agent comprises a reward function that is based on at least respective logarithms of respective uplink signal-to-noise-ratios of the respective user equipment.

10. The method of claim 8, wherein a constraint of the centralized deep reinforcement learning agent comprises respective power headrooms of the respective user equipment, respective received signal strength indicators of the respective user equipment, respective time difference of arrival values of the respective user equipment, or respective levels of interference of the respective user equipment.

11. The method of claim 8, wherein a state space of the centralized deep reinforcement learning agent comprises respective power headrooms of the respective user equipment, respective received signal strength indicators of the respective user equipment, respective time difference of arrival values of the respective user equipment, and respective levels of interference of the respective user equipment.

12. The method of claim 8, wherein a state space of a first decentralized deep reinforcement learning agent of the decentralized deep reinforcement learning agents of a first user equipment of the user equipment comprises a previous transmission power control value of the first user equipment, a battery level of the first user equipment, and an interference level caused by the first user equipment.

13. The method of claim 8, wherein the respective distributed deep reinforcement learning agents are configured to determine the respective transmission power levels for the respective physical uplink shared channel transmissions based on respective policies, and wherein the respective policies are updated based on a proximal policy optimization technique, based on a deep deterministic policy gradient technique, based on a deep-Q network technique, or based on an actor-critic technique.

14. The method of claim 8, wherein the centralized deep reinforcement learning agent comprises hidden layer and an output layer, wherein the hidden layer comprises a group of rectified linear units, and wherein the output layer comprises a sigmoid function or a softmax function.

15. A non-transitory computer-readable medium comprising instructions that, in response to execution, cause a system comprising at least one processor to perform operations, comprising:
determining, using a first reinforcement learning agent, respective transmission power control commands for respective devices of devices with which the system is enabled to communicate, wherein the respective devices execute respective second reinforcement learning agents that are configured to determine respective transmission power levels for respective physical uplink shared channel transmissions, and wherein the respective devices utilize the respective transmission power control commands as constraints in the respective second reinforcement learning agents; and
receiving the respective physical uplink shared channel transmissions from the respective devices according to the respective transmission power levels.

16. The non-transitory computer-readable medium of claim 15, wherein the respective second reinforcement learning agents are configured to determine the respective transmission power levels for the respective physical uplink shared channel transmissions based on respective policies, and wherein the operations further comprise:
periodically sending, to the respective second reinforcement learning agents, updates to the respective policies, based on the respective second reinforcement learning agents synchronizing with the first reinforcement learning agent.

17. The non-transitory computer-readable medium of claim 15, wherein the operations further comprise:
storing respective first state-action-reward sequences of the first reinforcement learning agent for respective time steps; and
storing respective second state-action-reward sequences of the respective second reinforcement learning agents for the respective time steps.

18. The non-transitory computer-readable medium of claim 17, wherein the respective first reinforcement learning agents are configured to determine the respective transmission power levels for the respective physical uplink shared channel transmissions based on respective policies, and wherein the operations further comprise:
adjusting respective parameters of the respective policies based on the respective first state-action-reward sequences, and based on the respective second state-action-reward sequences.

19. The non-transitory computer-readable medium of claim 15, wherein the first reinforcement learning agent implements an epsilon-greedy technique, a Thompson sampling technique, or an upper-confidence-bound technique during an exploration phase.

20. The non-transitory computer-readable medium of claim 15, wherein the respective second reinforcement learning agents implement an epsilon-greedy technique or a noise-injection technique during respective exploration phases.
